(19) United States
(12) Patent Application Publication
(10) Pub. No.: US 2008/0288129 A1
(43) Pub. Date: Nov. 20, 2008

(54) Vehicle Control System

(76) Inventor: Leonard H. Hancock, SR., Hummelstown, PA (US)

Correspondence Address: THE WEBB LAW FIRM, P.C., 700 KOPPERS BUILDING, 436 SEVENTH AVENUE, PITTSBURGH, PA, 15219, US

(21) Appl. No.: 12/106,568

(22) Filed: Apr. 21, 2008

Related U.S. Application Data
(60) Provisional application No. 60/925,467, filed on Apr. 20, 2007.

(51) Int. Cl. G05D 1/00

(52) U.S. Cl. 701/2; 341/176

(57) ABSTRACT

An electronic control system comprises a remote control radio transmitter (RCRT) and/or an auxiliary wired control (AWC) configured to transmit an operational control signal. A CANbus radio receiver (CRR) is in electronic communication with the RCRT and/or AWC. A programmable logic control system (PLC) is in electronic communication with the CRR via a CANbus connection. A control device is in electronic communication with the PLC to carry out the operational control signal.

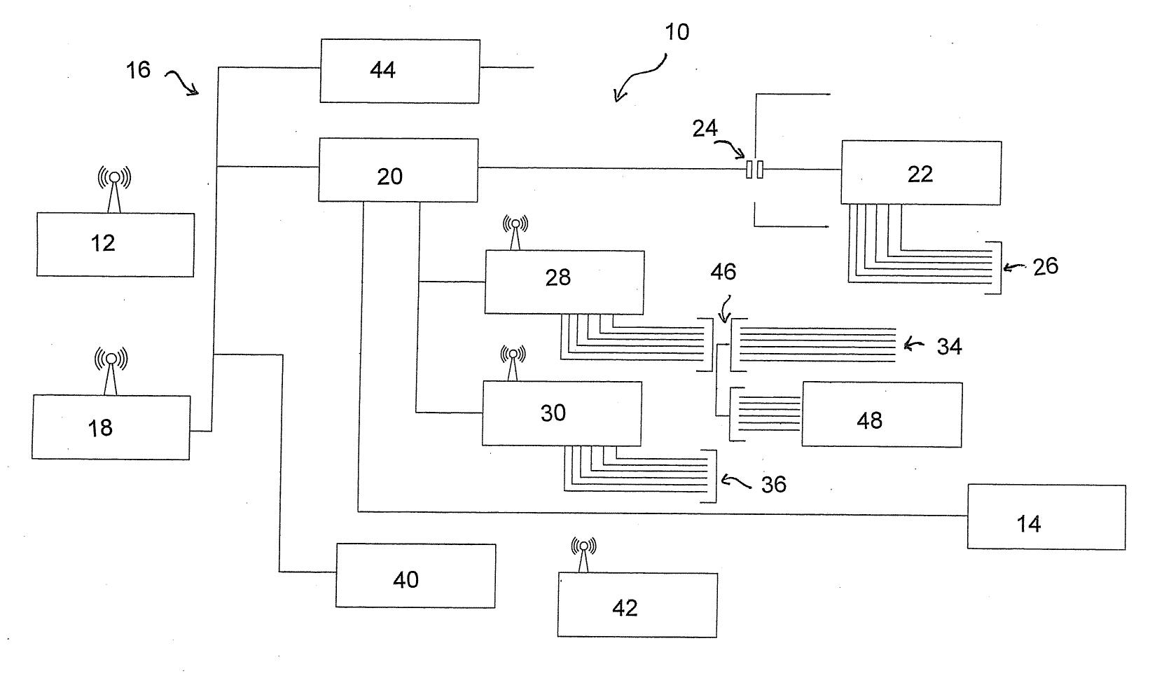

### CROSS REFERENCE TO RELATED APPLICATIONS

This application claims the benefit of U.S. Provisional Application No. 60/925,467 filed on Apr. 20, 2007, which application is herein incorporated by reference in its entirety.

### BACKGROUND OF THE INVENTION

1. Field of the Invention

This invention relates generally to a control system and method for controlling the operation of one or more vehicle systems, such as but not limited to hydraulic systems.

2. Technical Considerations

Some vehicles, such as fire or rescue vehicles, have hydraulic systems configured to drive various hydraulic components and emergency equipment, such as pumps, generators, valves, motors, tools, etc. The hydraulic pump(s) supplying hydraulic fluid to these hydraulic components are typically connected to the powertrain of the vehicle. Therefore, the vehicle powertrain must be monitored and controlled to control the hydraulic components.

Various control systems are known for controlling the operation of vehicle hydraulic systems. Typically, these known control systems include a primary control device having buttons or switches to operate or control the vehicle systems. For example, one button may send a signal to turn a pump on or off. When the button is pushed, a light or other indicator may illuminate to indicate that the command has been sent. However, in these known devices, the operator typically has no way of knowing whether the command has actually been executed. That is, just because the button has been pushed and the indicator is illuminated does not necessarily mean that the pump has actually been started. Also, even if the command has been executed (e.g., the pump has started), there is no way to monitor the status of the pump. If the pump should stop or suffer some other damage, the operator would typically not immediately be aware of it.

Therefore, it would be advantageous to provide a control device and method that reduces or eliminates some of these problems.

### SUMMARY OF THE INVENTION

An electronic control system comprises a remote control radio transmitter (RCRT) and/or an auxiliary wired control (AWC) configured to transmit an operational control signal. A CANbus radio receiver (CRR) is in electronic communication with the RCRT and/or AWC. A programmable logic control system (PLC) is in electronic communication with the CRR via a CANbus connection. A control device is in electronic communication with the PLC to carry out the operational control signal.

Another electronic control system comprises a remote control radio transmitter and a radio receiver in electronic communication with the radio transmitter. A data bus system is connected to the radio receiver. A programmable controller is connected to the data bus system. At least one input/output driver module is connected to the programmable controller via the data bus system. At least one hydraulic component is connected to the driver module. The programmable controller is connected to a vehicle control module through the vehicle data link serial bus.

A method of controlling the hydraulic system of a vehicle comprises the steps of: initiating a command signal at a remote control radio transmitter; transmitting the command signal via radio frequency to a radio receiver; transmitting the control signal from the radio receiver through a data bus system to a programmable controller; directing the control signal from the programmable controller through the data bus system to a input/output module; directing the control signal from the driver module to a hydraulic component; generating a verification signal from the hydraulic component that the command has been completed or not completed; transmitting the verification signal through the data bus system to the programmable controller and to the radio receiver; and transmitting the verification signal to the remote control radio transmitter and displaying whether the command signal has been completed or not.

### BRIEF DESCRIPTION OF THE DRAWING

The drawing FIGURE is a schematic view (not to scale) of a control system incorporating features of the invention.

### DESCRIPTION OF THE INVENTION

An exemplary control system of the invention for controlling a hydraulic system of a vehicle will first be described and then an exemplary method for operating the control system will be described.

As shown in the FIGURE, an electronic control system ECS 10 of the invention includes a remote control radio transmitter (RCRT) 12. The RCRT 12 is a two-way radio modem capable of sending control signals to various systems, components, sensors, etc, as will be described in more detail below. Additionally, the RCRT 12 can receive and display electronic data and messages regarding the components. An example of an RCRT 12 useful for the invention is a Model T2500 radio modem available from Omnex Control Systems.

The ECS 10 may also include an auxiliary wired control (AWC) 14 connected to a chassis controller area network (CANbus) system 16. The AWC 14 can have the same or similar control elements as the RCRT 12 but is physically connected to the CANbus system 16, such as by wires or cables. The AWC 14, if present, can be a functional duplicate of the RCRT 12 and can serve as a back up to the RCRT 12 should the remote function(s) fail. Alternatively, the AWC 14, if present, may be used instead of the RCRT 12, if desired. The RCRT 12 and AWC 14 may be fully integrated so that the desired operation(s) may be performed from either unit at any time regardless of the state of the other unit.

In remote operation, a desired operation is selected by utilizing a switch or other input device of some style, type, and/or size on the RCRT 12. The resultant control signal is transmitted to a CANbus radio receiver (CRR) 18. The CRR 18 is a two way radio modem that, in one embodiment, is connected to the CANbus system 16 such as by wires or cables. An exemplary CRR 18 is a Model R2170 radio modem available from Omnex Control Systems.

The CRR 18 then communicates the desired operation to a PLC based programmable controller (PLC) 20 via the CANbus system 16. An exemplary PLC 20 is a controller available from STW GmbH.

The PLC 20 then communicates the desired function to the truck chassis controller, e.g., a vehicle powertrain control module (PCM) 22 (or a vehicle programmable logic controller (PLC)) through or around the vehicle's OBD-II data link 24 to create the desired operation of one or more truck chassis systems, parts, or group of parts such as temperature sensors, brake systems, engine idle systems, or any other chassis component or system 25. The ECS 10 can have a plug configured to engage the vehicle's data link 24 so that the ECS can be plugged into the data link 24.

The information about the status of the desired chassis operation can be fed back through the information channel in reverse to light an indicator light on the RCRT 12 (and/or the AWC 14), be read out on a display on the RCRT 12 and/or the AWC 14, or otherwise be indicated at the RCRT 12 and/or AWC 14. Based on the chassis information received at the RCRT 12 and/or AWC 14, various other commands can be automatically initiated from the RCRT 12 and/or AWC 14 from the resulting information. Some such other commands can be, but are not limited to, displaying certain information on an LCD display, lighting a light, or initiation of another set of commands to the PLC 20 or one or more I/O driver modules 28 which can include, but are not limited to, the following of a logic sequence. The driver module 28 can be directly connected to the CANbus system 16. Suitable driver modules are available from STW GmbH. Alternatively, the driver module 28 can be a radio receiver driver module. Exemplary radio receiver driver modules useful for the invention include R160 (one way) and R2160 (two way) receiver driver modules available from Omnex Control Systems.

The RCRT 12 (or AWC 14) can initiate commands to the I/O driver module 28 through the PLC 20 utilizing the information received from the chassis sensors/components 25 through the PLC 20, truck chassis PCM 22 (or truck chassis PLC). Communication from the RCRT 14 or AWC 14 to the PLC 20 can be via a wired connection (such as an RS45 Serial Bus) or the wired connections may be replaced with a radio connection making a wireless connection.

The RCRT 12 or AWC 14 can also initiate commands to the I/O driver module 28 through the CANbus radio receiver 18 that are not dependant upon information received from the PLC 20, truck chassis PCM 22 (or truck chassis PLC). The I/O driver module 28 can control various inputs and outputs to or from a multitude of sensors, components, hydraulic, electrical, and mechanical systems and/or component parts.

One or more additional I/O driver modules 30 can be utilized depending upon the number of inputs and outputs (components) 34, 36 desired and the capacity of the I/O driver modules that are utilized.

Multiple signals both to and from the RCRT 12 and/or AWC 14 and/or other components can occur simultaneously, in a sequence, and/or in a sequence depending on preset logic. The logic may be programmed in any or all of the components that are capable of logic programming.

The status and/or value (e.g. temperature, “on,” or “off”) of any desired I/O can be displayed on the RCRT 12 and/or the AWC 14, or a fixed or remote display other than the RCRT 12 or AWC 14, such as an auxiliary display unit (ADU) 40, 42, as the lighting of an indicator light on the RCRT 12 or AWC 14, being read out on a display on the RCRT 12 or AWC14, or otherwise being indicated at the RCRT 12 and/or AWC 14 and/or ADU 40,42. For example, an ADU 40 can be directly connected to the CANbus system 16. Alternatively, an ADU 42 can be in radio connection with the PLC 20. An exemplary ADU 42 could be an R160 or R2160 device available from Omnex Control Systems.

A generator display unit (GDU) 40 can be connected to the CANbus system 16. The GDU 40 can receive inputs from a generator distribution enclosure regarding the status of a vehicle generator and this information can be provided to the PLC 20 through the CANbus system 16. A suitable GDU 40 is a Model Frog-D available from Fire Research Corporation.

Additionally, the ECS 10 can include a diagnostic connector 42 configured to engage a connector on the vehicle's diagnostic switch console (DSC) 44 so that the ECS 10 can be plugged into and control various vehicle systems through the vehicle's DSC 44.

### EXAMPLES

The following examples illustrate the operation of the ECS 10.

### Example 1

A switch on the RCRT12 or AWC 14 is switched to turn a hydraulic valve “on”. In order to turn the system “on”, certain changes in the status of the chassis must be made. Those changes are verified by the RCRT 12 or AWCT 14 prior to the RCRT 12 or AWC 14 initiating signals to the I/O driver module 28 to engage the hydraulic system. The RCRT 12 or AWC 14 initiates changes to the truck chassis though the PLC 20, truck chassis PCM 22 (or the truck chassis PLC) to make changes in the status of certain systems on the chassis (e.g., idle elevation). Once the RCRT 12 or AWC 14 receives feedback from the PLC 20 indicating that the necessary change(s) have been made, the RCRT 12 or AWC then signals the I/O driver module 28 to engage certain I/O functions to turn the hydraulic valve “on.” Engine RPM, oil temperature, hydraulic oil temperature, hydraulic pressure in multiple circuits, and/or other data, can be indicated or displayed on the RCRT 12 and/or AWC 12 and/or ADU 40, 42. This data can be used to control and/or initiate other system functions and/or programmed logic sequences with or without being displayed in some manner.

### Example 2

This will be an example of using the ECS 10 to supply hydraulic fluid to a hydraulic tool. The appropriate switch or button on the RCRT 12 is pushed to initiate a command to turn on the tool. This sends a radio signal to the CRR indicating that the operator wishes to turn on the hydraulic tool. The control signal is transmitted via the CANbus system 16 to the PLC 20. The PLC 20 analyzes the available vehicle information to insure that the command signal can be carried out. For example, to make sure that the vehicle powertrain is operating and appropriate hydraulic pumps are engaged. Next, the control signal will be transmitted to the appropriate I/O driver module 28 for the tool. The control signal is then transmitted through the CANbus system 16 and connector 42 to a solenoid valve (e.g., component 34) to open the solenoid valve and provide hydraulic fluid to the tool. The PLC 20 waits for a predetermined period of time to verify that the solenoid valve 34 has indeed been opened. For example, the PLC 20 can monitor a pressure transducer in the line of the solenoid valve 34 to verify an increase in hydraulic fluid pressure. The pressure transducer can send a signal to the PLC 20 that a minimum operating pressure has been reached. Once this verification has been transmitted to the PLC 20, the PLC 20 relays this information through the CANbus system 16 to the RCRT 12 (and AWC 14) to indicate, such as by a light, that the operation has been carried out. However, in the event that the PLC 20 does not receive the appropriate signal from the pressure transducer indicating that the solenoid valve 34 has been opened, the PLC 20 sends a signal to the RCRT 12 and AWC 14 that an error has occurred and an error indicator illuminates on these devices.

Thus, in the present invention, the ECS 10 not only controls various hydraulic functions of the vehicle but also provides positive indication of whether or not the desired commands have been executed. One area where this would be particularly important is if a command has been sent from the RCRT 12 to turn “off” a particularly tool (i.e. close a particular solenoid valve). If for some reason the shut off command is given and the valve is not turned off, the PLC 20 will send an error message to the RCRT 12 telling the operator that the valve has not been closed, as described above. This is particularly important for personnel operating the tool or changing out the tool. If a worker believes the hydraulic valve has been turned off and attempts to change a tool when the associated hydraulic pump is actually still operating, hydraulic fluid will shoot from the hose and may cause mechanical or personal injuries. Such an event is not possible with the present invention which provides the added safety benefit of knowing for sure whether or not the associated hydraulic valve has been turned off.

It will be readily appreciated by those skilled in the art that modifications may be made to the invention without departing from the concepts disclosed in the foregoing description. Accordingly, the particular embodiments described in detail herein are illustrative only and are not limiting to the scope of the invention, which is to be given the full breadth of the appended claims and any and all equivalents thereof.

What is claimed is:

1. An electronic control system, comprising:
a remote control radio transmitter (RCRT) and/or an auxiliary wired control (AWC) configured to transmit an operational control signal;
a CANbus radio receiver (CRR) in electronic communication with the RCRT and/or AWC;
a programmable logic control system (PLC) in electronic communication with the CRR via a CANbus connection; and
a control device in electronic communication with the PLC to carry out the operational control signal.

2. The electronic control system according to claim 1, wherein the control device is a truck chassis powertrain control module (PCM) or a programmable logic controller (PLC).

3. The electronic control system according to claim 1, wherein an operational control signal status signal is fed back to the RCRT and/or AWC to indicate the status of the selected operation.

4. The electronic control system according to claim 1, wherein the RCRT and/or AWC initiates command signals to an I/O driver module through the CRR utilizing information from one or more vehicle sensor components.

5. The electronic control system according to claim 1, wherein the RCRT and/or AWC initiates commands to an I/O driver module through the CRR independent of information from the PLC and/or PCM and/or PLC.

6. An electronic control system, comprising:
a remote control radio transmitter;
a radio receiver in electronic communication with the radio transmitter;
a data bus system connected to the radio receiver;
a programmable controller connected to the data bus system;
at least one input/output driver module connected to the programmable controller via the data bus system; and
at least one hydraulic component connected to the driver module, wherein the programmable controller is connected to a vehicle control module through the vehicle data link serial bus.

7. The electronic control system of claim 6, including an auxiliary display unit connected to the data bus system.

8. The electronic control system of claim 6, including an auxiliary display unit in contact with the programmable control via a radio frequency connection.

9. The electronic control system of claim 6, including an auxiliary wire console connected to the data bus system.

10. The electronic control system of claim 6, including a generator display unit connected to a hydraulic generator and also to the data bus system.

11. The electronic control system of claim 6, wherein the input/output driver module includes a plug connector configured to engage a diagnostic console of a vehicle.

12. A method of controlling the hydraulic system of a vehicle, comprising the steps of:
initiating a command signal at a remote control radio transmitter;
transmitting the command signal via radio frequency to a radio receiver;
transmitting the control signal from the radio receiver through a data bus system to a programmable controller;
directing the control signal from the programmable controller through the data bus system to a input/output module;
directing the control signal from the driver module to a hydraulic component;
generating a verification signal from the hydraulic component that the command has been completed or not;
transmitting the verification signal through the data bus system to the programmable controller and to the radio receiver; and
transmitting the verification signal to the remote control radio transmitter and displaying an indicator that the command signal has been completed or not.

13. The method of claim 12, including transmitting the verification signal to an auxiliary wire console connected to a wire data bus system.
